(19) United States
(12) Patent Application Publication
(10) Pub. No.: US 2009/0298040 A1
(43) Pub. Date: Dec. 3, 2009

(54) Review Notebook and Learning Method

(76) Inventor: Sebastien SCOTT, Kirkland (CA)

Correspondence Address: BROUILLETTE & PARTNERS, METCALFE TOWER, 1550 METCALFE STREET, SUITE 800, MONTREAL, QC, H3A-1X6, CA

(21) Appl. No.: 12/471,444

(22) Filed: May 25, 2009

(30) Foreign Application Priority Data
May 27, 2008 (CA) 2,632,356

(51) Int. Cl. G09B 19/00; B42D 1/00

(52) U.S. Cl. 434/365; 281/38

(57) ABSTRACT

A review notebook and a learning method using the same, the review notebook including a plurality of note pages arranged in repeating groupings of a predetermined number of note pages as well as a plurality of review pages occurring in bundles of at least one review page, the bundles of review pages being located between each of the groupings of note pages, and the learning method including the steps of recording information pertaining to a particular subject matter on the note pages of the review notebook and selectively transcribing the recorded information onto the review pages of the review notebook in order to summarize the recorded information. The regular occurrence of review pages amongst the note pages of the review notebook bringing about an intuitive systematic process for assimilating information whereby the number of note pages contained in each of the repeating groupings of note pages establishes the frequency of review while the number of review pages contained in each bundle of review pages establishes the extent to which the information being selectively transcribed from a grouping of note pages to a bundle of review pages needs to be summarized.

### CROSS-REFERENCE TO RELATED APPLICATIONS

The present patent application claims the benefits of priority of commonly assigned Canadian Patent Application No. 2,632,356, entitled “Review Notebook and Learning Method” and filed at the Canadian Intellectual Property Office on May 27, 2009.

### FIELD OF THE INVENTION

The present invention relates to a notebook, and more particularly, to a notebook having means to direct and optimize the assimilation and memorization of the information that is recorded within it.

### BACKGROUND OF THE INVENTION

Notebooks are commonly used by students of all ages in a variety of settings as a device for recording and storing information. To this end, most existing notebooks provide a plurality of paper sheets bound together by a binding mechanism. As a student progresses through a given academic period (e.g., term, semester, year), information is typically recorded in a successive manner within such a notebook until the plurality of paper sheets provided by said notebook has been exhausted. Some notebooks provide additional components such as dividers, which serve the purpose of segregating different types of information within a single notebook, typically on the basis of subject matter. However, it is important to note that students using the latter notebook will also tend to record information successively, all be it that they will do so within each section of said notebook until the plurality of paper sheets contained within said sections has been exhausted.

It therefore follows that, in general, the majority of existing notebooks are perceived by their user as a device in which information is merely recorded and consequently stored for retrieval at a later time. That is to say that the majority of existing notebooks do not bring about an intuitive systematic process by which the user is prompted to further manipulate the information he or she has recorded within them. And so, when students go about reviewing the information they have recorded within such notebooks for the purpose of learning (i.e., understanding and memorizing) said information, a significant number of them will simply read the information in question, for any number of times, in an effort to assimilate it. Of those students who opt to further manipulate the information they have recorded within such notebooks in order to facilitate its assimilation, many of them will resort to resources other than the notebook itself (e.g., index cards, notepads, sheets of loose paper) upon which they selectively transcribe (i.e., summarize) said information. In either case, it is worth noting that the frequency at which a student reviews the information he or she has recorded within such notebooks (i.e., the majority of existing notebooks) depends entirely upon that student and is very often a function of external factors (e.g., exams, tests, quizzes), at which points there may be a significant amount of information to be assimilated in a relatively short period of time. Accordingly, there is a need for a notebook which includes a review component occurring throughout said notebook at a given periodicity.

### OBJECTS OF THE INVENTION

A first object of the present invention is to enable its user, namely students, to more effectively record and organize information (e.g., course notes).

A second object of the present invention is to encourage its user, namely students, to regularly review said information.

A third object of the present invention is to direct and optimize the assimilation and memorization of said information.

Other and further objects and advantages of the present invention will be apparent upon an understanding of the illustrative embodiments described hereinafter or will be indicated in the appended claims of the present document. Moreover, various advantages not referred to herein will occur to one skilled in the art upon employment of the invention in practice.

### SUMMARY OF THE INVENTION

The objects and advantages referred to hereinabove are substantially realized by providing a review notebook comprising a plurality of note pages arranged in repeating groupings of a predetermined number of note pages and a plurality of review pages occurring in bundles of at least one review page, the bundles of review pages being located between each of the groupings of note pages.

The aforementioned objects and advantages are further substantially realized by providing a learning method for a review notebook comprising a plurality of note pages arranged in repeating groupings of a predetermined number of note pages and a plurality of review pages occurring in bundles of at least one review page, the bundles of review pages being located between each of the groupings of note pages, wherein the learning method comprises the steps of (a) recording information pertaining to a particular subject matter upon the note pages of the review notebook, and (b) selectively transcribing the recorded information onto the review pages of the review notebook in order to summarize the recorded information.

The regular occurrence of review pages amongst the note pages of the review notebook of the present invention brings about an inherent frequency of review, whereby the predetermined number of note pages contained in each of the repeating groupings of note pages necessarily establishes the frequency at which the user of the review notebook will be prompted to review the information he or she has recorded upon the note pages of the review notebook. Likewise, the number of review pages contained in each of the bundles of review pages of the review notebook establishes the extent to which the information being selectively transcribed (i.e., summarized) onto a bundle of review pages must be condensed. For the sake of simplicity, both of these parameters (i.e., the frequency of review and the summarization ratio) are concurrently referred to as the “review ratio” of the review notebook of the present invention: a part-to-part ratio of the number of note pages contained in each of the repeating groupings of note pages in the review notebook to the number of review pages contained in each bundle of review pages in the review notebook.

It follows that the present invention is primarily conceived for students who, in the course of partaking in educational activities (e.g., classes, seminars, lectures) geared toward learning a particular subject matter over a given period of time, are expected to record information pertaining to the subject matter so that it may be later reviewed and assimilated. However, this in no way implies that the user of the present invention need necessarily be a student per se. In fact, there may be a number of settings other then academia in which people can significantly benefit from the present invention. And so, although the term ‘user’ may often seem to denote a student in the present context, it is hereby clarified that students represent only a segment of the audience targeted by the review notebook of the present invention.

Furthermore, the term ‘page’ in the present context (e.g., note page, review page) refers to a single sheet of paper attached along one of its edges to the binding mechanism of the present invention, thereby providing the user with two planar surfaces upon which to inscribe information.

### BRIEF DESCRIPTION OF THE DRAWINGS

The above as well as other objects, features and advantages of the present invention will become more readily apparent by the following description, reference being made to the accompanying drawings in which:

FIG. 1 is a front perspective view of a preferred embodiment of the review notebook of the present invention;

FIG. 2 is a front plan view of the review notebook of FIG. 1, showing said review notebook open onto note pages;

FIG. 3 is a front plan view of the review notebook of FIG. 1, showing said review notebook open onto a note page and a review page;

FIG. 4 is a front plan view of the review notebook of FIG. 1, showing said review notebook open onto a note page and a divider;

FIG. 5 is a front plan view of the review notebook of FIG. 1, showing said review notebook open onto a note page and a sheet of detachable index cards; and

FIG. 6 is an exploded front plan view of the sheet of detachable index cards of FIG. 5.

### DETAILED DESCRIPTION OF THE PREFERRED EMBODIMENT

A novel review notebook will be described hereinafter. Although the invention is described in terms of specific illustrative embodiment(s), it is to be understood that the embodiment(s) described herein are by way of example only and that the scope of the invention is not intended to be limited thereby.

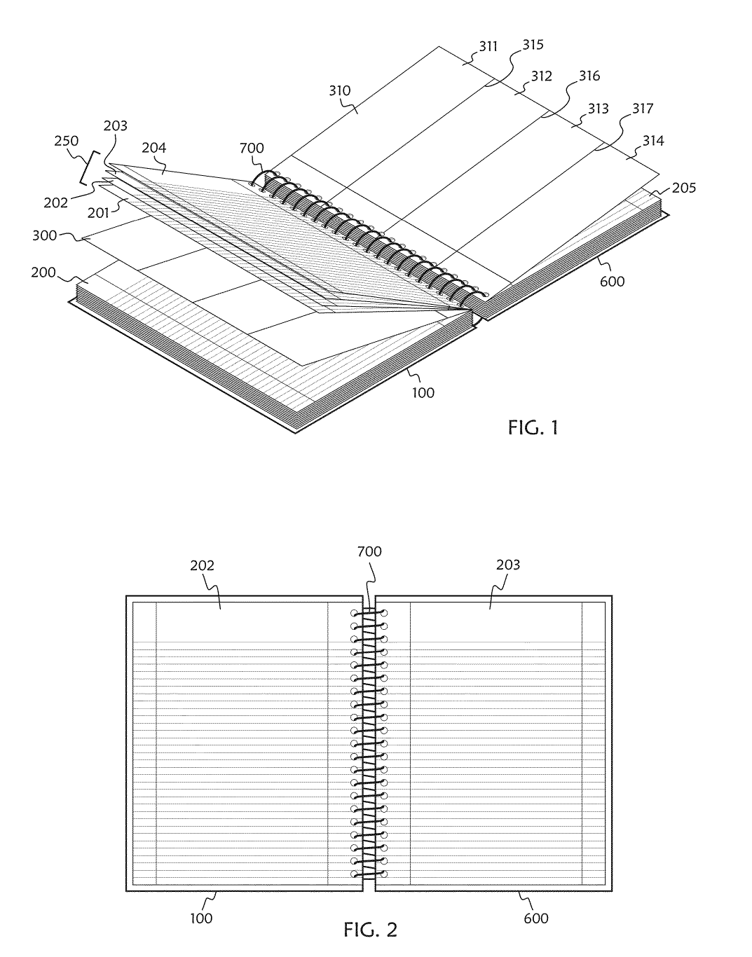

As shown in FIG. 1, the review notebook of the present invention primarily comprises a front cover 100; a plurality of note pages 200, 201, 202, 203, 204 and 205; a plurality of review pages 300 and 310; a back cover 600 and a binding mechanism 700 joining said components to one another.

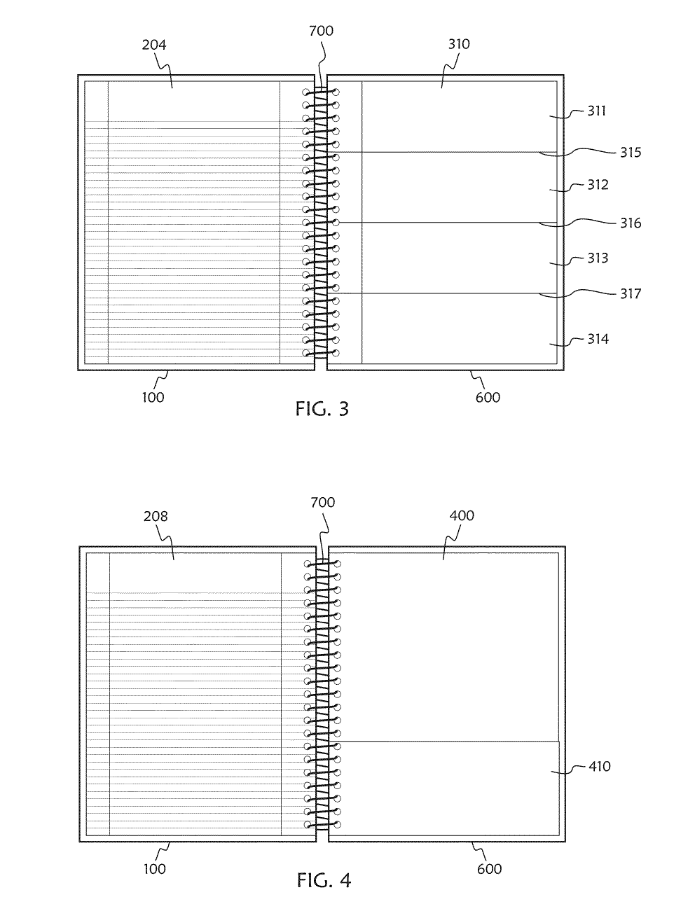

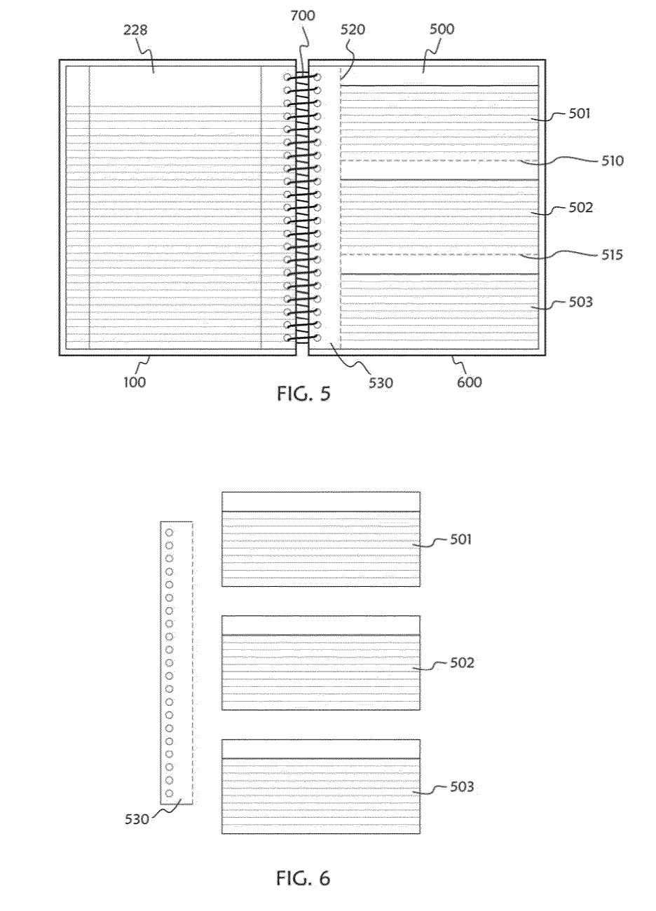

The note pages 200 to 205 (FIGS. 1, 2 and 3), 208 (FIG. 4) and 228 (FIG. 5) of the review notebook of the present invention are intended to be the primary location where the user records information pertaining to a particular subject matter. In a preferred embodiment of the review notebook of the present invention, said note pages are arranged in repeating groupings of a given number of note pages (one such grouping 250 being illustrated in FIG. 1), said groupings of note pages being separated from one another by one or more review pages 300 and 310. For example, there may be repeating groupings of 10 note pages separated by bundles of 1 or 2 review pages. It is to be understood that the number of note pages comprised in the repeating groupings of note pages as well as the number of review pages comprised in the repeating bundles of review pages may vary from this example and that these number of note pages and review pages are adaptable for different circumstances. The review notebook of the present invention may include a plurality of supplementary note pages so as to provide the user with a source of loose sheets of paper as well as a location where miscellaneous information can be recorded (e.g., homework, assignments, exercises, laboratory data). Said supplementary note pages may or may not be followed by one or more review pages. The note pages 200 to 205 (FIGS. 1, 2 and 3), 208 (FIG. 4) and 228 (FIG. 5) of the review notebook of the present invention may be of any given colour, weight (i.e., grammage), shape or size. Moreover, said note pages may be sequentially numbered throughout said review notebook, independently from other components of said review notebook, and said note pages may have any given form of guide lines printed thereupon.

The review pages 300 and 310 (FIGS. 1 & 3) of the review notebook of the present invention provide the user with specific locations upon which to selectively transcribe (i.e., summarize) the information he or she has recorded within said review notebook. More particularly, in a preferred embodiment of the review notebook of the present invention (FIG. 1), the occurrence of said review pages throughout said review notebook in bundles of one or more said review pages is intended to prompt the user to systematically review the information he or she has recorded within said review notebook whereby the information recorded within a given grouping 250 of note pages would necessarily be selectively transcribed (i.e., summarized) onto the bundle of one or more review pages 310 immediately following said grouping of note pages. However, this in no way precludes the user from incorporating information recorded elsewhere in said review notebook (i.e., on other note pages or other review pages) as part of the information being selectively transcribed (i.e., summarized) onto said bundle of one or more review pages.

In a preferred embodiment of the review notebook of the present invention, the number of review pages contained in each of said bundles of review pages is consistent throughout said review notebook. The review notebook of the present invention may include a plurality of supplementary review pages so as to provide the user with spare review pages should he or she require them. The review pages of the review notebook of the present invention may be of any given colour, weight (i.e., grammage), shape or size. Preferably, however, said review pages have at least one distinctive feature (e.g., color) so as to make them easily distinguishable from other components, namely note pages, of said review notebook. Moreover, each review page 310 (FIGS. 1 & 3) may be subdivided into a plurality of sections 311, 312, 313 and 314 by means of division lines 315, 316 and 317 printed thereupon. Each of said sections may correspond to a specific note page of the review notebook of the present invention whereby the information selectively transcribed (i.e., summarized) upon a given said section of review page 311, 312, 313 or 314 would preferably come from said corresponding note page 201, 202, 203 or 204, respectively (FIG. 1). Consequently, each of said sections may display the page number of said corresponding note page. Furthermore, the review pages 300 and 310 of the review notebook of the present invention may have any given form of guide lines printed thereupon, other than said division lines.

The review notebook of the present invention may include one or more dividers (i.e., a component which partitions said review notebook into sections) so as to enable the user to record different types of information (i.e., information pertaining to different subject matters) in a segregated fashion within said review notebook. The dividers 400 (FIG. 4) of the review notebook of the present invention, should said review notebook include such a component, preferably comprise a sheet of suitable material (e.g., paper, plastic, or a combination thereof) attached along one or more of its edges to the binding mechanism 700 of said review notebook. Said dividers may be of any given color, shape or size and may include a pocket 410 so as to provide the user with means of securely storing various planar materials (e.g., documents, index cards, data disks).

The review notebook of the present invention may include a plurality of detachable index cards 501, 502 and 503 (FIGS. 5 & 6) upon which the user can selectively transcribe (i.e., abridge, summarize, or reorganize) information he or she has recorded within said review notebook, be it on note pages 200, 201, 202, 203, 204, 205, 208 and 228 or review pages 300 and 310 of said review notebook, thereby providing the user with a more readily portable version of said information. Said plurality of detachable index cards is preferably provided in sheets of a given number of detachable index cards (FIG. 5), whereby a sheet of detachable index cards 500 consists of a single sheet of paper attached along one of its edges to the binding mechanism 700 of said review notebook, said sheet of paper bearing a number of horizontally 510, 515 and vertically 520 perforated lines delineating the given number of detachable index cards 501, 502 and 503 which comprise the whole of said sheet of paper except for the edge 530 of said sheet of paper which coincides with the binding mechanism 700 of said review notebook. It follows that said perforated lines are intended to act as tear lines, thereby providing the principal means by which said detachable index cards are made detachable from said sheets of detachable index cards (FIGS. 5 & 6).

In a preferred embodiment of the review notebook of the present invention, said sheets of detachable index cards may be grouped together in a given location of said review notebook or distributed throughout said review notebook at a given periodicity. Furthermore, said sheets of detachable index cards may be of any given colour, weight (i.e., grammage), shape or size. Preferably, however, said sheets of detachable index cards are made of a relatively heavy weight paper (e.g., cardstock) so that the detachable index cards provided by said sheets of detachable index cards may withstand repeated manipulation following their detachment from said sheets of detachable index cards. The detachable index cards 501, 502 and 503 of the review notebook of the present invention may be of any given shape or size. Said detachable index cards may be sequentially numbered throughout said review notebook, independently from other components of said review notebook, and said detachable index cards may have any given form of guide lines printed thereupon. Furthermore, each of said detachable index cards may correspond to a specific review page 300 and 310 of said review notebook, thereby encouraging the user to further selectively transcribe (i.e., summarize) the information he or she has recorded upon said corresponding review page. As such, each of said detachable index cards may display the page number of said corresponding review page.

The components described hereinabove (i.e., note pages, review pages, dividers, and sheets of detachable index cards) constitute the ‘inner components’ of the review notebook of the present invention and are referred to as such hereinafter.

The front cover 100 of the review notebook of the present invention primarily shields inner components of said review notebook from wear and tear, particularly when said review notebook is in its closed configuration. Accordingly, said front cover preferably comprises a sheet of sturdy and durable material (e.g., heavy weight paper, plastic, or a combination thereof) attached along one of its edges to the binding mechanism 700 of said review notebook. Said front cover may be of any given shape or size enabling it to fulfill its primary function as stated hereinabove. Moreover, said front cover may be of any given color and may display any given form of artwork (e.g., a picture, a design, or writing) on either its inner or outer surface, or both.

The back cover 600 of the review notebook of the present invention shields inner components of said review notebook from wear and tear while providing a structural backing for said review notebook. Accordingly, said back cover preferably comprises a sheet of sturdy and durable material (e.g., heavy weight paper, plastic, or a combination thereof) attached along one of its edges to the binding mechanism 700 of said review notebook. Said back cover may be of any given shape or size enabling it to fulfill its functions as described hereinabove. Furthermore, said back cover may be of any given color and may display any given form of artwork (e.g., a picture, a design, or writing) on either its inner or outer surface, or both.

In a preferred embodiment of the review notebook of the present invention, the various components described hereinabove (i.e., the note pages, the review pages, the dividers, the sheets of detachable index cards, the front cover and the back cover of said review notebook) are of the same relative shape and size so that, as a whole, said review notebook may have a uniform shape and size.

The binding mechanism 700 of the review notebook of the present invention unifies the various components of said review notebook and provides an axis about which said components pivot as they are accessed by the user of said review notebook. Said binding mechanism preferably enables said review notebook to be utilized with ease and comfort in a variety of different settings. In particular, the review notebook of the present invention is preferably capable of resting open upon a flat, horizontal surface without needing to be held in such a position by its user. Moreover, the various components of said review notebook other than the binding mechanism 700 of said review notebook preferably have a degree of rotational freedom about said binding mechanism such that said components may be arranged in a single stack when said review notebook is opened, so as to minimize the amount of space needed to accommodate said review notebook when it is being used. And so, although the binding mechanism 700 of the review notebook of the present invention may be of any given type (e.g., wire binding, adhesive binding, thread binding), said binding mechanism is preferably of the spiral coil type.

The features of the present invention which are believed to be novel are set forth with particularity in the appended claims of the present document. While illustrative and presently preferred embodiment(s) of the invention have been described in detail hereinabove, it is to be understood that the inventive concepts may be otherwise variously embodied and employed and that the appended claims are intended to be construed to include such variations except insofar as limited by the prior art.

1. A review notebook comprising:
a. a plurality of note pages, said note pages being arranged in repeating groupings of a predetermined number of said note pages; and
b. a plurality of review pages, said review pages occurring in bundles of at least one said review page, said bundles being located between each of said groupings of said note pages.

2. The review notebook of claim 1, further comprising supplementary note pages.

3. The review notebook of claim 2, wherein said supplementary note pages are located after said groupings of said note pages.

4. The review notebook of claim 1, wherein said note pages are sequentially numbered.

5. The review notebook of claim 1, further comprising supplementary review pages.

6. The review notebook of claim 5, wherein said supplementary review pages are located after said bundles of said review pages.

7. The review notebook of claim 1, wherein each of said review pages is divided into a plurality of sections.

8. The review notebook of claim 7, wherein each of said sections corresponds to one of said note pages of said review notebook.

9. The review notebook of claim 8, wherein each of said sections displays the page number of said corresponding note page.

10. The review notebook of claim 1, wherein said review pages are sequentially numbered.

11. The review notebook of claim 1, wherein said review pages are of a different color than said note pages.

12. The review notebook of claim 1, further comprising at least one divider.

13. The review notebook of claim 12, wherein at least one of said dividers further comprises a pocket, said pocket having a generally planar configuration.

14. The review notebook of claim 1, further comprising a plurality of sheets of detachable index cards, said sheets of detachable index cards comprising at least one detachable index card.

15. The review notebook of claim 14, wherein said sheets of detachable index cards are evenly distributed throughout said review notebook.

16. The review notebook of claim 14, wherein said sheets of detachable index cards comprise perforated lines delineating each of said detachable index cards.

17. The review notebook of claim 14, wherein each of said detachable index cards corresponds to one of said review pages of said review notebook.

18. The review notebook of claim 17, wherein each of said detachable index cards displays the page number of said corresponding review page.

19. A learning method for use with a review notebook, said review notebook comprising a plurality of note pages, said note pages being arranged in repeating groupings of a predetermined number of said note pages, and a plurality of review pages, said review pages occurring in bundles of at least one said review page, said bundles being located between each of said groupings of said note pages, said learning method comprising the steps of:
a. recording information pertaining to a particular subject matter upon said note pages of said review notebook; and
b. transcribing selected said information onto said review pages of said review notebook in order to summarize said information.

20. The learning method of claim 19, wherein said review notebook further comprises a plurality of sheets of detachable index cards, said sheets of detachable index cards comprising at least one detachable index card.

21. The learning method of claim 20, further comprising the step of further selectively transcribing said information onto said detachable index cards of said review notebook.
